(19) United States
(12) Patent Application Publication
(10) Pub. No.: US 2011/0273010 A1
(43) Pub. Date: Nov. 10, 2011

(54) ELECTRICAL NETWORK

(75) Inventor: Alain TARDY, PARIS (FR)

(73) Assignee: THALES, NEUILLY SUR SEINE (FR)

(21) Appl. No.: 13/118,914

(22) Filed: May 31, 2011

Related U.S. Application Data
(63) Continuation of application No. 12/937,256, now abandoned.

(30) Foreign Application Priority Data
Apr. 9, 2008 (FR) 08 01954

(51) Int. Cl. H02M 7/04

(52) U.S. Cl. 307/9.1

(57) ABSTRACT

The invention relates to an electrical network, which includes: two items of equipment able either to provide, or to consume electrical energy, transfer means hooked up between the two items of equipment and allowing the two items of equipment to exchange energy. The transfer means includes a reversible DC/AC converter, the converter being operated in voltage step-down or step-up DC/DC mode. In one embodiment of the invention, the first item of equipment is a high-voltage DC bus, and the network includes second items of equipment such as loads and a low-voltage DC bus to which a battery may be connected. The network includes several non-dedicated converters that can be connected between the first item of equipment and any of the second items of equipment.

### CROSS-REFERENCE TO RELATED APPLICATIONS

This application is a continuation of U.S. application Ser. No. 12/937,256, filed on Oct. 9, 2010, which is a National Stage of International patent application PCT/EP2009/054338, filed on Apr. 9, 2009, which claims priority to foreign French patent application No. FR 08 01954, filed on Apr. 9, 2008, the disclosures of which are incorporated by reference in their entirety.

### FIELD OF THE INVENTION

The invention relates to an electrical network. The invention finds a particular utility in aeronautics for wide-bodied commercial aircraft which comprise ever more onboard electrical equipment. Such equipment varies greatly in nature and its energy consumption varies greatly over time. By way of example, internal air-conditioning and lighting systems are in almost continuous operation while redundant security systems such as airfoil controls, are used only exceptionally.

### BACKGROUND OF THE INVENTION

Generally, the aircraft is furnished with three-phase electrical generators allowing power to be supplied to all the onboard electrical equipment, subsequently called loads. These generators deliver for example a voltage of 115 V at a frequency of 400 Hz to an AC bus of the aircraft. Aboard an aircraft are one or more main generators. These are rotating electric machines driven by the aircraft's engine or engines. Other generators can supply the AC bus such as for example an auxiliary generator well known in the literature by the name “Auxilliary Power Unit” and driven by a turbine dedicated to this generator or else a stack generator placed at the disposal of the aircraft when it is on the ground, by numerous airports. This stack generator makes it possible to avoid calling upon the auxiliary generator when the aircraft is on the ground.

Recently, subsequent to the appearance of high power loads (electric motors or AC sub-networks) that need to be supplied by three-phase voltage inverters, high-voltage DC buses supplied from the AC bus through rectifiers have been installed aboard aircraft. These high-voltage DC buses are well known in the literature by the name HVDC, standing for: “High Voltage Direct Current”. Hereinafter, the high-voltage DC bus will be called the HVDC bus.

The aircraft is also furnished with batteries making it possible to supply certain loads when the AC sources (stack generators or group) are not available.

In particular, the batteries must back up certain computers or certain critical electrical systems such as for example the flight controls, the braking, the thrust reversal of the engines or the starting of turbines through a low-voltage DC bus.

Batteries historically have a low voltage for example 24V DC (or optionally 48V C in the future) to supply as directly as possible power supplies of critical computers whose present standard is 28V DC and to limit the number of batteries in series.

For the higher power electrical loads such as for example the braking system, thrust reversal or engine starting, use is made of DC DC step-up converters so as to be able to use low-voltage batteries whose voltage is much less than that of the HVDC high-voltage DC bus. It would also be possible to envisage using specific batteries of higher voltage for these loads so as to limit or cancel the voltage boost required between the battery and the HVDC bus.

Low-voltage DC buses, for example 28V DC, are generally created from the AC bus by means of a transformation and rectification unit, produced by numerous aeronautical equipment manufacturers. This unit is well known in the literature by the name “Transformer Rectifier Unit” and will subsequently be called: TRU. The TRU is supplied by the AC bus of the aircraft and provides a DC voltage of 28V. The TRU generally comprises a transformer operating at the frequency of the aircraft's AC network, for example between 300 HZ and 1200 Hz.

The low-voltage batteries are then charged either directly by the low-voltage DC buses or through a battery charger implementing a DC DC converter.

Another solution for effecting the energy transfer linkup between a low-voltage DC bus and an HVDC bus consists in implementing either a pulse width modulation bidirectional DC/DC dedicated converter using a high-frequency transformer, or two independent head-to-tail DC DC converters each using a high-frequency transformer. By high frequency is meant a frequency of greater than 10 kHz.

This solution, using high-frequency pulse width modulation converters with a high power level, is generally much less reliable, more expensive and more unwieldy than the conversion solution implementing a TRU supplied by an AC network.

The TRU not being bidirectional, the AC bus is then fed from the low-voltage DC bus by a generator or by a dedicated three-phase inverter.

### SUMMARY OF THE INVENTION

The aim of the invention is to simplify the implementation of the following conversion functions by limiting the recourse to resources dedicated to these functions:
1. power supply of a DC bus of voltage X regulated from a DC bus of voltage Y;
2. charging of a battery of voltage X from a DC bus of voltage Y;
3. power supply of a DC bus of voltage Y regulated from a DC bus of voltage X or a battery voltage X;
4. charging of a battery of voltage Y from a bus of voltage X;
   In the conversion functions described hereinabove, X is smaller than Y. Other conversion functions can of course be extrapolated from the means of the invention.

For this purpose, the subject of the invention is an electrical network comprising:
two items of equipment able either to provide, or to consume electrical energy,
transfer means hooked up between the two items of equipment and allowing the two items of equipment to exchange energy,
   characterized in that the transfer means comprise a reversible DC/AC converter, the converter possibly being operated in voltage step-down or step-up DC/DC mode.

A first of the two items of equipment forms for example an electrical power supply bus such as for example a first DC bus. One of the second items of equipment forms for example a second DC bus to which may be hooked up an accumulation battery which can either be charged by the second bus or provide it with energy if so required.

In a particular embodiment where the two items of equipment are formed of two DC buses whose voltages are different X and Y, the transfer means allow the exchange of electrical energy between the buses in one direction and in the other. A battery can be hooked up to each of the buses. The invention makes it possible to command the exchange of energy from or to the battery or batteries. The transfer means make it possible to regulate the voltage of one of the buses when it is supplied by the other or to regulate the current flowing between the DC buses.

For this purpose, the transfer means comprise between the two buses:
1. one or more reversible DC/AC multiphase inverters, whose DC input is connected to the bus of voltage Y and which may be operated:
   in voltage step-down three-phase voltage inverter mode;
   in parallel monophase voltage step-down DC/DC converter mode;
   or in parallel monophase voltage step-up DC/DC converter mode;
2. optionally, connected at the AC output of the inverter, a voltage step-down TRU whose transformation ratio makes it possible to deliver the voltage X from the voltage Y;
3. optionally a reversible DC/AC three-phase inverter, whose DC input is connected to the bus of voltage X, possibly being operated in step-down three-phase voltage inverter mode and whose AC output is connected to a voltage step-up TRU whose transformation ratio makes it possible to deliver the voltage Y from the voltage X present at the input of the inverter.

In a particular embodiment where the first item of equipment forms an electrical power supply bus such as for example an HVCD bus, the network comprises several second items of equipment, a plurality of reversible converters making it possible to exchange energy between the bus and the various second items of equipment, and routing means making it possible to vary an association between the converters and the second items of equipment. Advantageously, the converters can all exchange energy with each second item of equipment. An arbitrary second item of equipment does not possess any dedicated converter.

Stated otherwise, a reversible DC/AC converter may be used to supply various loads of the aircraft from the electrical power supply bus of the aircraft. It is possible to pool several converters through the routing means making it possible to vary the association between converters and loads, the batteries or a second DC bus being considered to be a particular load or a source. Thus, in case of unavailability of a converter, it is possible to assign another converter to the link between batteries and bus by using the routing means. These routing means can operate in real time, thus improving the availability of the batteries and more generally the reliability of the aircraft's electrical network.

The invention is described in relation to an electrical network aboard an aircraft. Of course it may be implemented in any other sector such as for example the automobile sector where electrical motorization and consequently the use of batteries is spreading. The batteries may be replaced with any other energy storage element such as for example a capacitor or a supercapacitor. For convenience, in the subsequent description, the term battery will be used for any energy storage element.

### BRIEF DESCRIPTION OF THE DRAWINGS

The invention will be better understood and other advantages will become apparent on reading the detailed description of an embodiment given by way of example, which description is illustrated by the appended drawing in which:

FIG. 1 represents an electrical diagram of a network installed aboard an aircraft;

FIG. 2 represents in a schematic manner a TRU used in the network of FIG. 1;

FIG. 3 schematically represents an exemplary embodiment of a converter used in the network of FIG. 1;

For the sake of clarity, the same elements will bear the same labels in the various figures.

### DETAILED DESCRIPTION

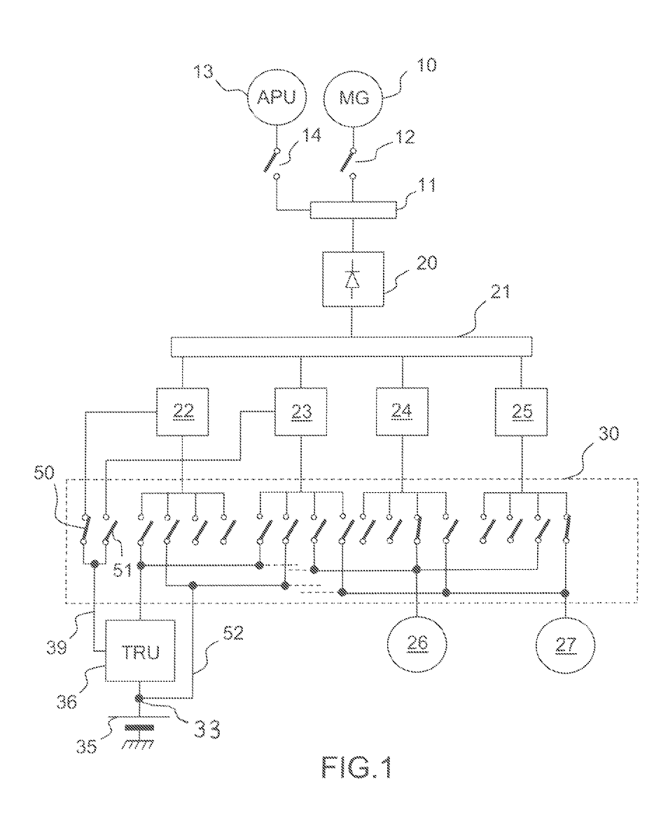

FIG. 1 schematically represents various items of electrical equipment on board an aircraft notably a wide-bodied commercial aircraft. A main generator 10 denoted MG is driven by one of the aircraft's engines. The generator 10 operates when the aircraft's engines operate and delivers for example a voltage of 115 V at a frequency of 400 Hz to an AC network 11 of the aircraft. Disconnection means 12 making it possible to open the link linking the generator 10 to the network 11. An auxiliary generator 13, denoted APU, is driven by a turbine dedicated to this generator 13 so as to provide the voltage of 115 V to the AC network 11. Likewise, disconnection means 14 make it possible to open the link linking the auxiliary generator 13 to the network 11. The turbine operates using the aircraft's fuel and is implemented when the aircraft is on the ground.

Aboard the aircraft is also installed a rectifier 20 connected to the AC network 11 and making it possible to deliver a DC voltage to a high-voltage DC electrical power supply bus 21 denoted HVDC, the abbreviation standing for: “High Voltage Direct Current”. A voltage commonly used for the high-voltage DC bus 21 is 540V.

The DC bus 21 supplies several energy converters 22 to 25 each intended to supply a load, for example 26 and 27 by way of routing means 30. The representation of FIG. 1 is schematic. In practice, a load may be supplied by several converters or else one converter can supply several loads. Certain loads may be supplied with DC voltage and the associated converter then converts the voltage of the DC bus 21 into a voltage usable by the load considered. In a wide-bodied aircraft, there are numerous loads using an AC voltage of 115 V at a frequency of 400 Hz. To supply these loads, the converters 24 and 25 are inverters. Known inverters have the particular feature of being reversible.

Each converter 22 to 25 may be assigned in real time to the various loads 26 and 27 as a function of each load's instantaneous requirement and as a function of the availability of each of the converters 22 to 25. The routing means 30 make it possible to vary in real time the association between converters 22 to 25 and loads 26 and 27. The association of the converters 22 to 25 and loads 26 and 27 is done as a function of the instantaneous-current requirement and of the instantaneous mode of command of the load associated therewith. The mode of command of the load depends essentially on the type of load. By way of example which is commonly implemented in an aircraft may be cited the regulation of speed, torque or position, anti-icing or deicing, operation at constant power and diverse strategies for engine command (defluxing, command with or without sensor).

The routing means 30 comprise for example electrically controlled breakers making it possible to associate each converter with all the loads which are compatible therewith. By compatible is meant the fact that several loads can operate with the aid of the same converter, notably when they require the same power supply, for example a voltage of 115 V at a frequency of 400 Hz. The converters making it possible to deliver one and the same power supply form a group whose members are interchangeable. The various members of a group are advantageously identical. This reduces the production costs of the converters by standardizing their manufacture and makes it possible to simplify aircraft maintenance by stocking just one type of converter. As will be seen subsequently, certain types of converters can deliver several different power supplies as a function of the mode of operating the converter. Thus, with one and the same group of converters it is for example possible to associate loads operating under AC voltage, for example 115V 400 Hz, and loads operating under DC voltage such as batteries for example.

The group is reconfigurable as a function of the instantaneous requirement of the loads that may be supplied by this group. It is not necessary to have a converter dedicated to each load. Indeed, the loads do not all operate simultaneously. The number of converters of one and the same group is defined as a function of the instantaneous maximum power that the set of loads associated with a group can consume. This power is less than the addition of the maximum powers of each load. The routing means 30 therefore make it possible to reduce the number of onboard converters and therefore the mass of these converters.

Moreover, reconfiguration makes it possible to improve the availability of the loads. Indeed, in the case of a faulty converter, another converter of the same group can immediately take over to supply a given load. Certain critical loads, such as for example airfoil controls, can thus operate with a secure power supply without, however, requiring the redundancy of a converter dedicated solely to these controls. The set of converters of one and the same group then forms a common resource capable of supplying a group of loads. Inside one and the same common resource, the various converters of which it is composed are undifferentiated.

A particular load of the network consists of a battery 35 hooked up to one of the converters by way of the routing means 30. In a conventional manner on an aircraft, it is known to use a battery of nominal voltage 28V DC. Other battery voltages are of course possible for the implementation of the invention. On the basis of a 540V DC bus 21, it is possible to operate the converter 22 in such a way that it delivers the 28V DC voltage directly to a second DC bus 33 that can supply the battery 35. It is possible to insert between the second bus 33 and the battery 35 a battery charger making it possible to regulate the current charging the battery. It is also advantageous to insert a transformation and rectification unit 36, subsequently called a TRU, between the converter 22 and the battery 35, to charge the battery 35. The TRU 36 is supplied with 115V 400 Hz AC voltage and provides a DC voltage of 28V. The use of a TRU facilitates the operation of the converter 22 used as inverter which receives a DC voltage of 540V. It is possible to consider the set formed by the TRU 36 and the battery 35 as a load that can be associated with one of the converters by the routing means 30.

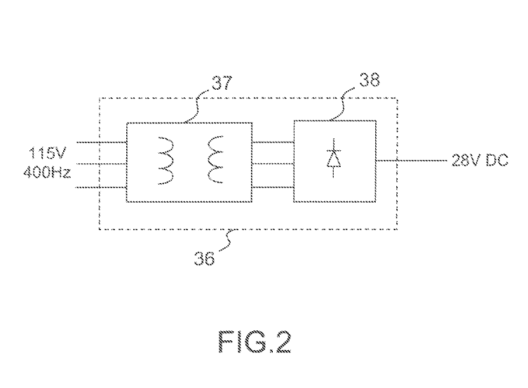

FIG. 2 schematically represents an exemplary TRU 36 comprising a transformer or autotransformer 37 receiving the three-phase 115V 400 Hz AC voltage delivered by the converter 22 operating as an inverter. In the embodiment where the TRU 36 is situated between the converter 22 or 23 and the DC bus 33, the transformer 37 makes it possible to lower the voltage that it receives. The transformer 37 delivers a three-phase voltage of the order of 20V which once rectified by a rectifier 38 makes it possible to obtain the 28V DC voltage to supply the battery 35. The rectifier 38 is for example produced by means of a full-wave diode bridge delivering a voltage, smoothed by capacitors.

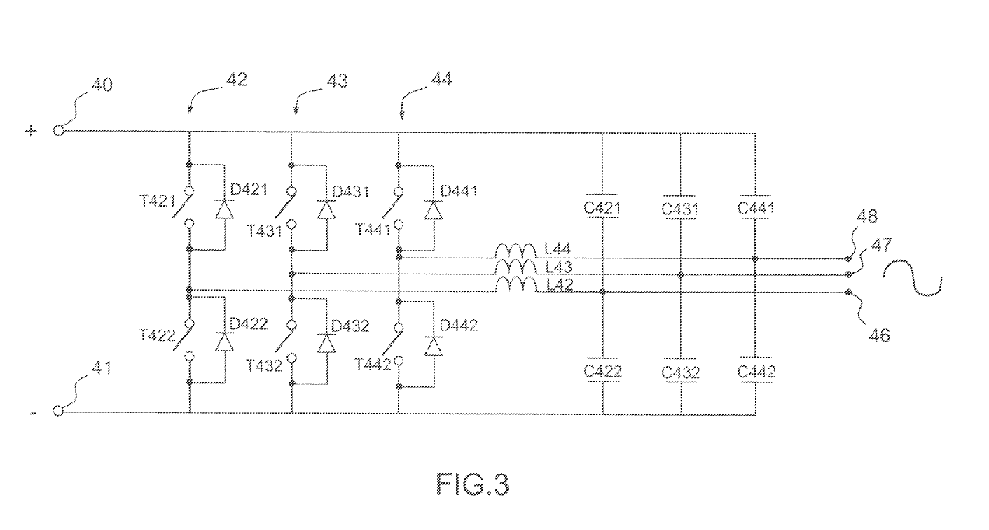

FIG. 3 represents schematically and in a simplified manner an exemplary embodiment of one of the converters 22 to 25. The converter comprises two terminals 40 and 41, the terminal 40 being hooked up to the positive pole of the DC bus 21 and the terminal 41 being hooked up to the negative positive pole of the DC bus 21. Between the terminals 40 and 41, the converter comprises three branches 42, 43 and 44 each comprising two electronic breakers, T421 and T422 for the branch 42, T431 and T432 for the branch 43 and, T441 and T442 for the branch 44. In each branch 42, 43 and 44 the two breakers are linked in series and a diode is connected in parallel with each breaker. The label of the diode is D followed by the numerical part of the label of the associated breaker, for example the diode D 421 is connected to the terminals of the breaker T 421. Each diode is connected in antiparallel fashion with respect to the direction of the current flowing in each breaker from the positive terminal 40 to the negative terminal 41 of the DC bus 21. The breakers T421 to T442 are for example all identical and of insulated-gate bipolar transistor type well known in the literature under the acronym IGBT standing for: “Insulated Gate Bipolar Transistor”. In each branch 42, 43 and 44, at the common point of the two breakers, a choke, respectively L42, L43 and L44 is connected by its first terminal. A second terminal, 46, 47 and 48 of each choke, respectively L42, L43 and L44, allows the converter to supply a three-phase load. Capacitors C421 to C442 are linked between one of the terminals 46, 47 and 48 and one of the terminals 40 and 41. When the electrical energy is provided to the converter by the DC network 21, the converter can operate as a voltage inverter. On the other hand, when the electrical energy is provided in the form of AC between the terminals 46, 47 and 48, for example by a regenerative load or a battery, the converter can operate as a current rectifier.

It is possible to use a TRU 36 comprising internal means for regulating the DC voltage that it delivers to the battery 35. But advantageously, the regulation of the voltage delivered to the battery 35 is done with the aid of means for operating the converter 22 associated with the battery 35, for example by varying a duty ratio of the converter 22. The means for ensuring this regulation comprise a link 39 linking the TRU 36 to the converter considered. The routing means 30 can comprise for this purpose breakers 50 and 51 making it possible to select the converter connected to the input of the TRU 36. When the converter 22 operates as an inverter to supply the battery 35, the voltage measured at the output of the TRU 36 on the bus 33 makes it possible to adapt a duty ratio of opening and closing of the breakers T421 to T442 so as to maintain the DC voltage delivered by the TRU in a predetermined span. An electronic device, belonging to the converter 22, makes it possible to control the opening and closing of the breakers T421 to T442. In a known manner, such a device is compulsory in each converter, or associated with it, so that the breakers that it comprises operate in a coherent manner. It is therefore advantageous to offload the function for regulating the voltage provided to the battery 35 of the TRU 36 to the associated converter by using its electronic control device. This disposition also makes it possible to improve the overall reliability of the electrical network. Indeed, by simplifying the TRU, which no longer comprises any internal regulating means, its reliability increases. Moreover, failures, if any, of an electronic control device of a converter are alleviated in real time by a possible reconfiguration of the converters inside a group with which the battery 35 is associated.

When the battery 35 is to be used to supply the DC bus 21, a reconfiguration of the routing means 30 is effected to circumvent the TRU 36. Stated otherwise, the battery 35 is connected directly to the terminals 46, 47 and 48 without passing through the TRU 36 which is monodirectional. This connection is carried out, via a link 52, by the routing means 30. The converter, such as represented in FIG. 3, then operates as a monophase booster. More precisely, each branch and its associated choke makes it possible to boost the voltage provided by the battery 35. For example, for the branch 42, the breaker T422 is used alternatively to store energy in the choke L42 in the form of a current passing through it and the diode D421 so as to release the energy stored toward the terminal 40 linked to the DC bus 21. The three branches and the associated chokes operate with a phase shift of π/3. The converter may be operated to operate as a multiphase inverter so as to supply the battery 35 through the TRU 36 or as N monophase voltage boosters so as to supply the DC bus 21 from the battery, N representing the number of phases of the inverter, the N boosters being phase-shifted by π/N.

Operation as N monophase voltage boosters exhibits a drawback when the voltage of the DC bus 33 is much less than the voltage of the DC bus 21. The efficiency of the converter is then fairly mediocre. To alleviate this drawback, it is possible to insert between the first DC bus 21 and the chosen converter a TRU making it possible to supply the first bus 21 from the second bus 33. This TRU then comprises a transformer making it possible to raise the voltage that it receives. This embodiment requires the converter to be completely disconnected so as to connect the terminals 40 and 41 of the converter to the low-voltage DC bus 33, rather than to the HVDC DC bus 21. The TRU is then connected between the terminals 46, 47 and 48 on the one hand and the HVDC DC bus 21.

In a more general manner, an inverter such as represented in FIG. 3 may be operated in a first direction, when it receives energy from the bus 21, either as a multiphase inverter or as N voltage step-down DC/DC converters. The inverter can also be operated in a second direction, opposite from the first, either as a current rectifier, when it receives an AC voltage from a regenerative load, or as N voltage booster DC/DC converters. The operating of the converter may be modified in real time simultaneously with the breakers of the routing means 30.

This type of reversible DC/AC converter that can be operated in voltage step-up or step-down DC/DC mode is much simpler to produce and much more reliable than a bidirectional DC/DC converter comprising a high-frequency transformer.

1. An electrical network comprising:
two items of equipment able either to provide, or to consume electrical energy;
transfer means hooked up between the two items of equipment and allowing the two items of equipment to exchange energy,
wherein the transfer means comprises a reversible DC/AC converter, the converter being operated in voltage step-down or step-up DC/DC mode.

2. The electrical network as claimed in claim 1, wherein a first of the two items of equipment forms an electrical power supply bus, and wherein the network comprises second items of equipment, a plurality of reversible converters making it possible to exchange energy between the bus and the various second items of equipment, and routing means making it possible to vary an association between the converters and the second items of equipment.

3. The electrical network as claimed in claim 2, wherein the converters can all exchange energy with each second item of equipment.

4. The electrical network as claimed in claim 3, wherein the converters are identical.

5. The electrical network as claimed in claim 1, wherein the first item of equipment is a first DC bus and wherein the second item of equipment is a second DC bus to which an accumulation battery is hooked up.

6. The electrical network as claimed in claim 5, wherein between the converter and the second DC bus, the network comprises a transformation and rectification unit.

7. The electrical network as claimed in claim 6, wherein the transformation and rectification unit situated between the converter and the second DC bus comprises a transformer making it possible to lower the voltage that it receives.

8. The electrical network as claimed in claim 6, wherein the voltage of the second DC bus is regulated with the aid of means for operating the converter.

9. The electrical network as claimed in claim 1, wherein between the first DC bus and the converter, the network comprises a transformation and rectification unit making it possible to supply the first bus from the second bus.

10. The electrical network as claimed in claim 9, wherein the transformation and rectification unit situated between the first DC bus and the converter comprises a transformer making it possible to raise the voltage that it receives.

11. The electrical network as claimed in claim 1, wherein the converter can operate as multiphase inverter or as N monophase voltage boosters, N representing the number of phases of the inverter, the N boosters being phase-shifted by π/N.
